(19) United States
(12) Patent Application Publication
(10) Pub. No.: US 2009/0119242 A1
(43) Pub. Date: May 7, 2009

(54) System, Apparatus, and Method for Internet Content Detection

(76) Inventor: Miguel Vargas Martin, Oshawa (CA)

Correspondence Address: MILLER THOMPSON, LLP, Scotia Plaza, 40 King Street West, Suite 5800, TORONTO, ON, M5H 3S1, CA

(21) Appl. No.: 11/931,790

(22) Filed: Oct. 31, 2007

(51) Int. Cl. G06N 5/02; G06F 15/173

(52) U.S. Cl. 706/48; 709/224

(57) ABSTRACT

A method of detecting content communicated via a network is provided consisting of the steps of: classifying the content into a first category and a second category by means of a classification process; detecting one or more behaviour parameters of a user accessing the content, where the behaviour patterns are associated with the content either consisting of first category content or second category content; and further classifying the content into first category content and second category content based on the behaviour parameters detected for the user. The first category content generally consists of restricted or illegal content, and the second category content generally consists of unrestricted or legal content. The classification process consists of a pattern recognition technique that includes a training phase and a testing phase. The training phase provides statistical properties of a plurality of data objects which are labelled prior to testing as either restricted or unrestricted. The testing phase determines whether one or more data objects of content communicated via the network constitute restricted content or unrestricted content. A related system, network apparatus and computer program is provided.

### FIELD OF THE INVENTION

The present invention relates to a network-based detection system capable of identifying unauthorized or illegal Internet activity. The present invention further relates to a system for detecting Internet content involving child pornography.

### BACKGROUND OF THE INVENTION

A number of approaches currently exist, at different levels, to combat access to and downloading of restricted content on the Internet, for example child pornography. The technical approaches can be classified within a traffic-type model that consists of visual, text, and encrypted type traffic. Visual-type traffic consists of moving pictures, or frames. Subclasses of this type are still pictures such as JPEG files. These files are typically transferred using P2P applications. Text-type traffic consists of items such as e-mails and documents; this includes descriptions of child pornography, or suspicious material such as chat room sessions in which an individual inquires about another's age. Encrypted file-transfers represent a more challenging scenario, where it may not be computationally feasible to analyze file contents.

Current methods for combating the exchange of unauthorized information are relatively primitive, time consuming and require direct human intervention. For example, in pursuit of offenders, law enforcement officers conduct manual searches on the Internet, or use the Internet to establish contact with offenders in order to make arrests and remove censured content. This host-based approach is generally resource-intensive and inefficient. Implementing detection mechanisms in hosts or internal network equipment based on prior art technology is generally ineffective and is limited to the size of the network in question.

In particular, efforts need to be focused upon finding ways in which access to restricted material can be identified efficiently with relatively little human intervention.

Enabling network devices to detect restricted content files along communication channels has been suggested in order for example to identify suspect network segments involved in an illegal file transfer. This area has become more important with the emerging, increasing use, and sharing of digital visual (image and video) files. The problem is generally approached by identifying visual files based on their semantics. The semantics of a file are determined according to a set of characteristics (e.g. color contrast and shapes) learned a-priori from similar files. There are a number of commercial products which can classify visual file content (e.g. U.S. Pat. No. 7,231,392, and U.S. Pat. No. 6,904,168) however intermediate network devices (e.g., routers) are not currently able to analyze visual files on-line for a number of reasons including packet fragmentation and performance constraints.

Various products identify and filter restricted content on the Internet for the purpose of blocking such content from specific computers or servers (e.g. U.S. Pat. No. 7,231,392, and U.S. Pat. No. 7,082,429). The conventional method is to block the restricted content by analyzing its URL address and characters of the transferred data. However, such methods cannot assist in blocking multimedia data. Also, the blocks are limited to the servers and computers on which the product is installed.

There is a need for a system, method and computer program that identifies restricted Internet activity that is efficient, effective, and easy to implement.

### SUMMARY OF THE INVENTION

In one aspect of the present invention a method of detecting content communicated via a network is provided which includes: (a) classifying the content into a first category and a second category by means of a classification process; (b) detecting one or more behaviour parameters of a user accessing the content, where the behaviour patterns are associated with the content either consisting of first category content or second category content; and (c) further classifying the content into first category content and second category content based on the behaviour parameters detected for the user.

In another aspect of the invention, the first category content is restricted or illegal content, and the second category content is unrestricted or legal content.

In a still other aspect of the invention, the classification process includes or defines at least (a) a training phase, and (b) a testing phase.

In yet another aspect of the invention the classification process consists of a pattern recognition technique.

In another aspect of the present invention, a system for detecting content communicated via a network is provided the system including a a network utility made part of or linked to the network, the network utility being operable to: (a) classify the content into a first category and a second category by means of a classification utility made part of or linked to the network utility; (b) detect one or more behaviour parameters of a user accessing the content, where the behaviour patterns are associated with the content either consisting of first category content or second category content; and (c) further classify the content into first category content and second category content based on the behaviour parameters detected for the user.

In a still other aspect of the invention, a network utility is provided that can be linked to or otherwise implemented in connection with a network, the network utility including a content detection utility that is operable to: (a) classify the content into a first category and a second category by means of a classification utility made part of or linked to the network utility; (b) detect one or more behaviour parameters of a user accessing the content, where the behaviour patterns are associated with the content either consisting of first category content or second category content; and (c) further classify the content into first category content and second category content based on the behaviour parameters detected for the user.

In yet another aspect of the invention, the network utility is a network component such as a router.

### BRIEF DESCRIPTION OF THE DRAWINGS

FIG. 1 illustrates a representative embodiment of the system of the present invention.

In the drawings, one embodiment of the invention is illustrated by way of example. It is to be expressly understood that the description and drawings are only for the purpose of illustration and as an aid to understanding, and are not intended as a definition of the limits of the invention.

### DETAILED DESCRIPTION OF THE INVENTION

The present invention relates generally to monitoring Internet activity. It is a novel method, system and apparatus that enables detection and classification of downloaded, transferred, or otherwise accessed restricted content (e.g. pornography or terrorist communications) at the network infrastructure level of the Internet. As mentioned, one aspect of the invention is particularly directed to a system for detecting and classifying download activity involving child pornography on a desired Internet network.

It should be understood that the phrase ‘restricted content’ is used broadly and should not be, limited to one specific type of restricted content (i.e. child pornography), the present invention may be adapted to detect and classify a variety of identifiable content as described herein.

A content detection method is provided that includes (1) classifying content into restricted and unrestricted content, and (2) analyzing the Internet behaviour associated with the content, and identifying Internet behaviour that is consistent with the accessing restricted content. In one aspect of the invention, a score is associated with Internet behaviour that is consistent with accessing the restricted content. The combination of (1) and (2) enable detection of restricted content with improved accuracy.

One aspect of the present invention involves a content detection system. The detection system is operable to initiate (1) a training phase, and (2) a testing phase with respect to Internet content detection, as is common in pattern recognition techniques. During the training phase, the system learns statistical properties of a large number of files (e.g., images or text) which are labeled a-priori into the categories of restricted and non-restricted (for example as obscene and non-obscene. These statistical properties are then used during the testing phase to determine whether an analyzed file contains more properties that belong to the set of obscene properties or to the set of non-obscene properties. Based on this testing process, the system deems a file as either obscene or non-obscene.

It should be noted that the content detection system is explained in relation to image content. The content detection system provide in this disclosure may also be used to identify other restricted Internet behaviour. An example of such a specific implementation is provided below.

The training phase is implemented, in one aspect thereof, using estimators, namely (1) a probabilistic pattern classifier, and (2) a linear classifier. In one particular implementation, (1) a maximum likelihood estimator (MLE) and (2) a stochastic learning weak estimator (SLWE) is used. Since, information exchanged on the Internet is not simply limited to textual conversations in an email or chat room the SLWE is an accurate method for dealing with non-stationary data (moving images or clips interspersed with text). JPEG images are considered to be part of the visual non-stationary data and they are not limited to moving frames. The transmission channel may be unencrypted since encryption will increase the entropy of the data which will increase the difficulty of learning in the training phase. It should be understood that the present invention may be applied to encrypted data, however, certain implementations thereof that require fast processing based on current decryption technology may be less viable in relation to encrypted data.

In one aspect of the invention, the training phase of the present invention, two vectors are used to classify the restricted from the non-restricted packets. By extracting statistical properties from the labeled packets (i.e., those that have been sorted into the restricted and non-restricted vectors), it is possible to use the gathered information as a basis for comparison. The content detection system also includes a classifier. The features extracted from the training phase, with any needed adjustments, are then input into the classifier that is used in the validation phase of the SLWE. The classification of the content is then repeated using the MLE.

One aspect of the training phase, as noted above, aims initially to extract the statistical features of the packets corresponding to all images in the training dataset, producing one vector for each class. The following algorithm produces the two vectors, when it is run for each dataset.

Algorithm Frequencies

```
1. Initialize an array B of counters to zero
2. For each image I of the training dataset of class j:
    2.1 For each 8-bit byte bⱼ of I:
        2.1.1 Increment B[bⱼ] by 1
3. Initialize an array Vⱼ of probabilities to zero
4. For k = 0 to 255
    4.1 Set Vⱼ[k] = B[bⱼ] /total number of 8-bit bytes of the set of images.
```

The algorithm is used separately for the restricted and non-restricted training datasets. The output of the algorithm is a feature vector, an array V₀ or Vₙ, one for each dataset restricted and non-restricted respectively.

In a further aspect of the present invention, once the statistical characteristics are extracted into the feature vectors V₀ and Vₙ, the next step is to use an estimator to extract the features of the image to be classified, namely a vector V′. The two algorithms (SLWE and MLE) have been tested for this purpose.

In another implementation of the present invention, the classification rule consists of assigning an unlabeled package to the class, restricted or non-restricted, that minimizes the distance between V′ and the trained arrays V₀ or Vₙ. Four metrics were used for this purpose, which are later explained in detail, namely the Euclidean distance, the weighted Euclidean distance, a variance approach, and the counter distance. Each method calculated the distance from the actual packet to the two labeled vectors and then a classification was made as to whether a packet is obscene or not.

In a further implementation of the present invention, and to take into consideration that restricted images may not be totally contained in a single packet due to fragmentation, the images may gradually be reduced from 100% to 20%, and the false negatives and false positives may then be recorded based on the classification results. The higher the percentage of the image (i.e. the lower the fragmentation), the less the number of likely misclassifications, i.e. false positives or false negatives. To interpret the results, it should be understood that the best performance is generally where there is an almost equal allocation (fifty/fifty) in both domains so that there is an overall low error rate when it comes to the classification phase. However, it is important to note that this is an aspect of the invention which may be adjusted by a person skilled in the art when adapting the invention to a particular implementation in that the desired false positive or false negative threshold will vary in the circumstances. In some cases it will be better to assign a higher false positive in others it will be better to assign a higher false negative threshold this problem can be modeled in terms of minimizing the decision risk, which is more general than that of minimizing the classification error.

Further Details on Estimators

As explained above, before using a classification metric, statistical characteristics of datasets need to be extracted. In a particular implementation of the present invention the frequency for each of the symbols is obtained, from 0 to 255, for a given image that shall be classified.

The Maximum Likelihood Estimator

The maximum likelihood estimator (MLE) is a conventional technique that aims to maximize the likelihood that a given sample generates using a specific probabilistic model, either parametric or non-parametric. In one aspect of the present invention, it is assumed that we deal with a multinomial random variable with 256 possible realizations (one symbol for each 8-bit ASCII value). It has been shown that the likelihood is maximized when the estimate for each symbol is given by the frequency counters divided by the total number of bytes in the image. This has been explored for example by R. Duda, P. Hart, and D. Stork. Pattern Classification, 2^{nd} Edition, Wiley-Interscience, 2000; and A. Matrawy, P. C. van Oorschot, A. Somayaji, “Mitigating network denial of service through diversity-based traffic management,” Proc. 3^{rd} Intl. Conf. on Applied Cryptography and Network Security (ACNS), New York, USA, Jun. 7-10, 2005). The algorithm may be described as follows:

MLE Algorithm

```
1. For each image H captured by the router:
    1.1 Initialize an array C of counters to zero
    1.2 For each 8-bit byte bⱼ of H:
        1.2.1 Increment C[bⱼ] by 1
2. Initialize an array V′ of probabilities to zero
3. For k = 0 to 255
    3.1 Set V′[k] = C[bⱼ] / total number of 8-bit bytes of this image.
```

The algorithm produces an array V′ that contains the estimates for each 8-bit byte in the testing image H. That vector V′ is then input to the classification rule, which decides on the class based on a distance function and the trained feature vectors.

The SLWE Algorithm

Estimators like the one described by the MLE algorithm suffer from the lack of capturing quick changes in the distribution of the source data, e.g. dealing with non-stationary data, that is, from different types of scenarios. Oommen et al. proposed a stochastic learning weak estimator (SLWE) (B. J. Oommen and L. Rueda, Stochastic Learning-based Weak Estimation of Multinomial Random Variables and Its Applications to Pattern Recognition in Non-stationary Environments. Pattern Recognition, Vol. 39, 2006, pp. 328-341. 2005). The SLWE combined with a linear classifier may successfully be used to deal with problems that involve non-stationary data and has been effectively used to classify television news into business and sports news (B. J. Oommen and L. Rueda, “On Utilizing Stochastic Learning Weak Estimators for Training and Classification of Patterns with Non-Stationary Distributions”. Proc. of the 28th German Conference on Artificial Intelligence, Koblenz, Germany, 2005, Springer, LNAI 3698, pp. 107-120).

In one aspect of the present invention, each image to be classified is read from the testing dataset, and is used as input to a classification method, the classification method consisting of extracting statistical features into a feature vector. The source alphabet contains n symbols (n=256), which conform the possible realizations of a multinomial random variable, and whose estimates are to be updated by using the SLWE rules described. While this rule generally requires a “learning” parameter, λ, it has been found that a good value for multinomial scenarios should be close to 1, e.g. λ=0.999 (S. Theodoridis and K. Koutroumbas, Pattern Recognition, 3^{rd} Edition, Elsevier Academic Press, 2006.). The algorithm may be described as follows:

SLWE Algorithm

```
1. For each image H captured by a router:
    1.1 Initialize each entry of the feature vector V′ to 1/256
    1.2 For each 8-bit byte bⱼ of H:
        1.2.1 For k = 0 to 255
            1.2.1.1 If i ≠ bᵢ then
                V′[k] = λ*V′[k]
                Else
                V′[bᵢ] = V′[bᵢ] + (1−λ) Σ V′[k] (for k≠i)
```

The classification method may be described validated using labeled images, and where necessary adjustments are applied. Note that in an actual classification process the label of each image may not be known. In a further implementation of the present invention, to classify the complete image four different distance functions may be utilized, each is further detailed in the following section.

Classification Distances

In another aspect of the invention the content is classified based on similarity of identified content to the restricted and unrestricted files referred to. In a particular aspect of the invention, similarity is determined using a suitable distance function (also referred to as “metric”). In one aspect of the present invention, a metric is selected that requires a desirably low level of processing power. It should also be understood that especially in the context of implementation of the present invention in a network router a metric is desirable that enables relatively fast processing in order to enable analysis of data traffic based on the present invention.

Generally speaking a linear metric may be desirable as it is likely to fulfill the requirements described. It was found that the four metrics described below were suitable for the purpose of classification of content as described.

It should be understood that different components of the feature vectors may have different weight in classification of an arbitrary image. Some entries of the feature vector may be more important than other entries, or some entries may have more noise than other entries. Therefore, the choice of a metric plays an important role in the performance of the present invention. It should also be understood that it is possible that other metrics may also be suitable and the list below is not meant to be exhaustive.

In a particular aspect of the present invention, the distances between the feature vector of an arbitrary image and the feature vectors of restricted images and non-restricted images may be based on a group of known distance metrics described. It should be understood that the selection of this particular group for the purposes of classification as described in this invention impacts on the operation of the technology described, and selection of such group is not obvious to those skilled in the art.

Euclidean Distance

In this metric, it is assumed that all entries in the feature vector have equal weight. The Euclidean distance between two feature vectors V and V′ is defined by the following equation:

$$d ( V , {V}^{′} ) = \sqrt{{\sum }_{i = 0}^{255} {( V [ i ] - {V}^{′} [ i ] )}^{2}}$$

Weighted Euclidean Distance

This distance is also known as the Mahalanobis distance when the covariance matrix is considered as a diagonal matrix. Is is assumed that different entries in the feature vector have different importance in classifying images. It is also possible to consider an entry in the feature vector to be of less importance than another entry if its variance is greater than the variance of another entry. We define the weighted factor w as w=1/σ², and the distance by:

$$d ( V , {V}^{′} ) = \sqrt{{\sum }_{i = 0}^{255} \frac{{( V [ i ] - {V}^{′} [ i ] )}^{2}}{{σ}^{2}}}$$

Variational Distance

This distance is usually named as variational distance when V and V′ represent probability distributions, and L1 distance or city block distance when V and V′ are considered as vectors of n-dimensional space. In one aspect of the present invention, this distance may be calculated as follows:

$$d ( V , {V}^{′} ) = \sqrt{{\sum }_{i = 0}^{255} \vert V [ i ] - {V}^{′} [ i ] \vert}$$

Counter Distance

In this metric the distance of a test vector T is defined from two fixed vectors V and V′ by: d(V, T)=number of elements for which:

|V[i]−T[i]|<|V′[i]−T[i]|

d(V′, T)=number of elements for which:

|V[i]−T[i]|≧|V′[i]−T[i]|

Improvement of Accuracy Because of Metrics

By reference to the parameters used in the Weighted Euclidean metric, in this section we explain the contribution of metrics to the accuracy of the present invention..

Let Vₚ be the feature vector for child pornography images Vₚ=(vₚ vₚ₁, v_{p2,} . . . , vₚᵢ, . . . , σₚₙ) and σ²=(σ₀², σ₁², . . . , σᵢ² . . . σₙ²) be the standard deviation vector, where σᵢ² is the standard deviation of vₚᵢ.

The standard deviation σᵢ² for the feature vector vₚᵢ that is important for a child pornography image will be smaller than the standard deviation of the feature that are non important for a child pornography image for example. Ideally, a feature that is not important for the child pornography images will be important for non-child pornography images.

Thus, in the feature vector vₚ=(vₚ₀ vₚ₁, vₚ₂, . . . , vₚᵢ, . . . , vₚₙ), some of the features are important for the child pornography images and the rest of them for the non-child pornography images (upon certain threshold criteria). Now, let vₚₛ₁ vₚₛ₂, vₚₛ₃, . . . vₚₛₖ denote the features that are important for child pornography images and vₚₜ₁, vₚₜ₂, . . . vₚₜₘ, the features that are important for non-child pornography images (where k+m=n), and vₚₛₓ is different from v_{pty}, for all r=1, . . . , k, and all s=1, . . . , m).

Let us assume that k<m which means that the number of features important for the child pornography images is less than the number of features important for non-child pornography images. Thus, let us rewrite the Weighted Euclidean Distance equation:

$${d}_{WE} ( {V}^{′} , {V}_{p} ) = \sqrt{{\sum }_{r = 1}^{k} {{w}_{sr} ( {v}_{sr}^{′} - {v}_{psr} )}^{2} + {\sum }_{r = 1}^{m} {{w}_{tr} ( {v}_{tr}^{′} - {v}_{ptr} )}^{2}} \qquad ( 1 )$$

If we use as weighted factor wₛₛ=1/σₜ², then we are expecting to have a bigger weighted factor for features that are important for child pornography than for non child pornography images. Conversely, when we use wₛ=σₜ², actually we have used a bigger weighted factor for features that are important for non child pornography images. The three diagrams below show the results for these two weighted factors.

Since false positive rate is lower for the weight factor wₛ=σₜ² than for wₛ=1/σₜ², we are achieving a smaller number of errors in detecting non-child pornography images when using wₛ=σₜ². In this case, the values of wₜᵣ in the second summation of Eq. (1) are greater than wₛᵣ in the first summation, and since k<m, we can say that the second summation dominates in calculating the distance d_{WE}(V′, Vₚ).

The false negative rate is almost the same for both weighted factors. This rate looks a little bit lower for wₛ=1/σₜ² at than for wₛ=σₜ² when the processed image percentage is lower. The system commits almost the same number of errors in detecting child pornography images. In this case the wₛᵣ in the first summation of Eq. (1) are greater than w,r in the second summation but since k<m we can say that both summations have almost the same weight in determining the distance d_{WE}(V′, Vₚ).

Overall, the error rate is lower when using wₛ=σₜ² than when using wₛ=1/σₜ². Therefore, the system is more accurate in classifying an image as child pornography or non-child pornography when using weighted factor wₛ=σₜ² than when using wₛ=1/σₜ². Ironically, to detect child pornography images (or image portions), it is best to try to detect non-child pornography images (or portions) and consequently, those images (or portions) that are not detected will be deemed as child pornography.

In summary, assuming the classes are normally distributed and the features are independent, then the classification rule as per Eq. (1) will result in the optimal (in the Bayesian context) classifier. That is, it is the classifier that assigns the packet to either child pornography or non-child pornography depending on the Mahalanobis distance from the class mean. Then, the larger value of wₛ, the more the features in the first summation of Eq. (1) will contribute to classify the sample. This rule, a particular case of the general scenario for normally distributed classes ([9, pp. 41-45]), minimizes the probability of classification error.

Implementation

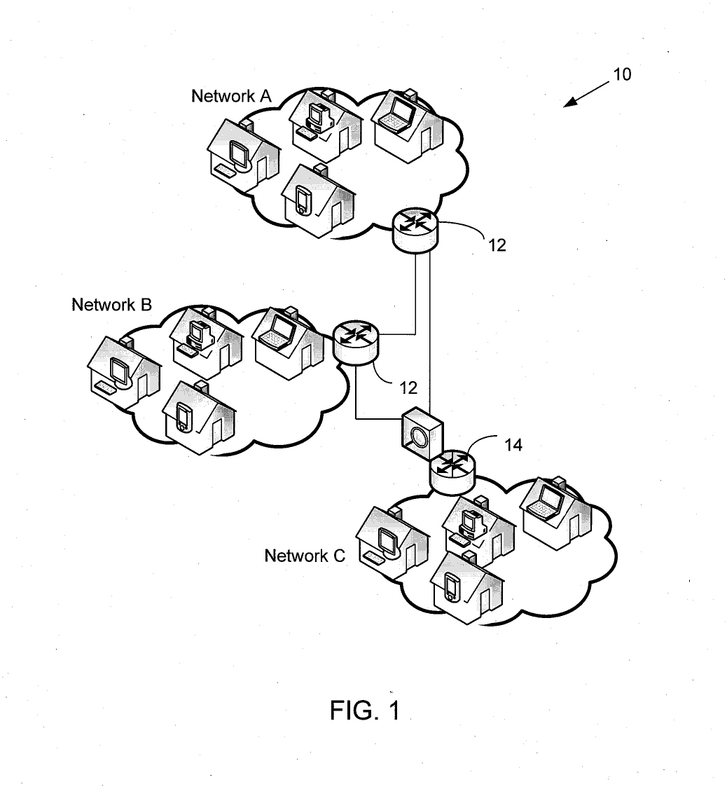

In one aspect of the present invention the implementation, the algorithms described below are implemented as part of a known network infrastructure. FIG. 1 illustrates a representative implementation in which a router by means of the content detection utility of the present invention in order to analyze through traffic to determine whether packets are obscene or not, and increment the obscenity score accordingly. This obscenity score can be later consulted (e.g., by law enforcement directly or by the Internet service provider upon law enforcement request).

In a particular implementation of the present invention, the method described above is implemented to an Internet data router, network router, or equivalent, used as illustrated in FIG. 1. In FIG. 1, the Internet (10) is represented by three interconnected networks, namely Network A, Network B, and Network C. Networks A and B each have a traditional router (12) that does not include the functionality of the present invention. Network C on the other hand includes the modified network router (14) that embodies the functionality of the invention. Network router (14) is operable to analyze traffic between Network C and the broader Internet (10) as explained.

It should be understood that the algorithms described above, as implemented in a network router, are scalable. The algorithms may be applied independently within a network router, and do not require communication with other peers, and so the deployment may be done “one router at a time”.

Since costs and the logistics of deployment may make it impractical to enhance all network routers of a given network, in one implementation of the present invention it is possible to simply take advantage of Internet connectivity properties to find an appropriate small set of routers to enhance. Consider a graph representing a network of autonomous systems where each node represents an autonomous system. Internet topology generally follows power-law relationships, which induce hubs in the network (i.e., network routers attached to “many” other network routers). Enhancing the routers of a (small) vertex cover including the hubs would be most advantageous (M. Faloutsos, P. Faloutsos, and C. Faloutsos, On power-law relationships of the Internet topology, SIGCOMM 1999, Boston/Cambridge, USA, pages 251-262, Aug. 31-Sep. 1, 1999).

It should be understood that while the invention is described in relation to the Internet, the Internet is one example of a computer network in relation to which the present invention may be implemented. The present invention contemplates the application of the technology described to various other networks such as private networks, corporate networks, local area networks, wireless and wired networks, and the like.

In a particular aspect of the invention, a vertex cover of a network of linked network routers consists of enhancing first those routers with most neighbours until all the links between network routers of interest have been covered. Park et al. have shown experimentally that a vertex cover of the autonomous-system-level Internet can be constructed with approximately 20% of the total number of nodes (K. Park and H. Lee, On the effectiveness of route-based packet filtering for distributed DoS attack prevention in power-law internets, SIGCOMM 2001, San Diego, USA, August 2001). This vertex cover algorithm is well known, and is operable to iteratively select a router of highest degree (i.e., with highest number of neighbours) and add the router to the vertex cover, deleting the associated links (i.e., connections to their neighbours) until all links are covered.

In one aspect of the present invention, it is expected that enhancing the network routers as selected by the vertex cover algorithm, will be efficient in detecting restricted material (such as obscene material for example) since the routers of the vertex cover tend to be the ones with most neighbours, and therefore the ones that will likely forward most of the traffic in the network. In accordance with the description of the implementation of the present invention, the system of the present invention should be understood to include a system that provides network connectivity that includes one or more components that enable the functionality described.

The invention is further illustrated by suggesting specific physical network implementations. Physical implementation of the present invention can be performed in a number of ways:
1. Application of the invention described within a network router. For example for core network routers of network infrastructures, the invention may be readily implemented in a manner that is known, for example by adapting the network router software generally embedded in such hardware with the functionality described above. The functions could also be provided by hardwiring the processes described to the network router.
2. The invention described may be implemented as a software component of a LINUX™ box. For example, the software component may be based on a custom application or the like of the LINUX netfilter function. The netfilter is a framework inside the LINUX kernel that allows a module to observe and modify packets as they pass through the IP stack, and is a standard component of LINUX kernel 2.3 and latter versions; or alternatively.
3. The invention described may also be implemented as a separate network component that acts as a tapping device or equivalent. The tapping device may include a hardware implementation of the functionality described and is operable to analyze packets passing through a core link of the network.

Example of Operation

In one aspect of the present invention, the “sensitivity” of the content detection system is adjustable. For example, an application included in the system, or linked or linkable to the system, enables an authorized user to establish a “sensitivity score” or “obscenity score” (in one implementation) for the system. Another feature of the detection system is the flexibility to be trained with new obscene files every certain time period; for example the files used in the training phase may not be accurate enough to describe the statistical properties of obscene files ten years from now, and at that point the system can be trained again using new obscene files.

In a further embodiment of the present invention, each network router has one obscenity score that reflects the level of obscenity transmitted through the given network router. The score is initially set to 0. Obscenity scores are computed based on the output of a classification algorithm (note that the classification algorithm used is independent of the invention described herein, as long as the error rate of the classification is within acceptable levels, see A. Shupo, M. Vargas Martin, L. Rueda, A. Bulkan, Y. Chen, P. C. K. Hung. Toward Efficient Detection of Child Pornography in the Network Infrastructure. IADIS International Journal on Computer Science and Information Systems. Vol. 1, No. 2, pp. 15-31, Oct. 31 2006. Each time the classification algorithm deems an IP packet as restricted, the obscenity score is incremented by 1, for example.

It should be understood that for the purposes of maintaining accuracy of the system it may be desirable to adjust the obscenity score in this way from time to time. Unrestricted content may be likely to result in “false positives” for restricted content. For example, downloading of legal pornography may be common in a specific area based on demographics such that within that area in order to maintain accuracy, the obscenity score is adjusted. Other factors might contribute to an increase in “false positives” such as for example hot weather resulting in more pictures being taken and exchanged where the subjects are nude or partially nude. These factors would be addressed by the adjustability described.

It is well-known that pedophilia is a mental condition that is rarely overcome by individuals. Thus, once a pedophile begins acting upon this condition, the individual will continue this activity indefinitely (e.g., until captured and convicted). In one aspect of the present invention, where an individual transmits child pornographic images over the Internet, the obscenity score of the router serving this individual will increase accordingly. Even though the classification algorithm has an error rate, the obscenity score will increment as the individual keeps transmitting this kind of images over and over, and the obscenity score of this particular router will stand out amongst neighbouring routers.

In a further embodiment of the present invention, once the obscenity score is beyond a threshold, a trigger or a “silent” alarm is set off which informs law enforcement to pursue further validation. The alarm may be an email, or a simple UDP packet that starts an alarm routine in the police headquarters. The alternative is to do nothing. In this case, the objective is that law-enforcement will consult obscenity scores of an ISP regularly as part of their routine patrols, or as part of an investigation of a particular individual.

Interpretation of Obscenity Scores

In one aspect of the present invention, obscenity scores can be reset to 0 automatically, e.g., every month, or whenever after some time period the obscenity score did not reach the threshold. An interesting way of interpreting obscenity scores is by correlating them with known behavioural patterns such as sudden increase of the score during certain time of the day in a certain day of the week (e.g., Friday between 11 PM and 3 AM). The optimal value of the threshold will vary depending on the characteristics of the network in question (e.g., typical type of traffic, amount of traffic, etc.).

The described technology does not reveal actual information about the contents of the traffic nor the individual responsible for transmitting obscene packets. The described technology is simple, feasible, and will help law enforcement to narrow down their search for pedophiles and will assist them in the prosecution of suspected criminals.

The computer program of the present invention, in one aspect thereof consists of one or more software components that are adapted to filter content in accordance with the method of the present invention. The computer program is understood as a content detection utility that can be implemented in various ways to a network such as: (a) including the content detection utility in the programming of a network component such as a router, (b) linking a computer including the content detection utility to a network component such as a router so as to detect content passing through the router based on the functionality of the content detection utility, or (c) loading or otherwise providing the functionality of the content detection utility to a server or other computer linked to the network.

It should be understood that the present invention contemplates various tools that enable the deployment and management of the system described. For example, the system may includes for example a plurality of network routers deployed a various locations, all linked to a central management utility that enables an administrative user to monitor their performance and upload programming related to the operation of the network routers such as updates to obscenity scores or classification programming. The system of the invention may be integrated with various other systems for monitoring and/or acting on specific Internet behaviour.

It should also be understood that while the invention is explained principally in relation to pornography the invention is also applicable to other Internet activity involving content and behaviour that is indicative of the content (text, image or whatever) falling into one class or another for example hate speech, terrorist communications, communications regarding unionization and the like.

What is claimed is:

1. A method of detecting content communicated via a network, comprising the steps of:
(a) classifying the content into a first category and a second category by means of a classification process;
(b) detecting one or more behaviour parameters of a user accessing the content, where the behaviour patterns are associated with the content either consisting of first category content or second category content; and
(c) further classifying the content into first category content and second category content based on the behaviour parameters detected for the user.

2. The method of claim 1 wherein the first category content is restricted or illegal content, and the second category content is unrestricted or legal content.

3. The method of claim 2 in which the classification process includes or defines at least (a) a training phase, and (b) a testing phase.

4. The method of claim 1 in which the classification process consists of a pattern recognition technique.

5. The method of claim 3 in which the training phase provides statistical properties of a plurality of data objects which are labelled prior to testing as either restricted or unrestricted.

6. The method of claim 5 in which the testing phase determines whether one or more data objects of content communicated via the network constitute restricted content or unrestricted content.

7. The method of claim 6 in which the data objects are analyzed to determine whether they contain more properties related to restricted content or more properties related to unrestricted content.

8. A system for detecting content communicated via a network comprising:
(a) a network utility made part of or linked to the network, the network utility being operable to:
(i) classify the content into a first category and a second category by means of a classification utility made part of or linked to the network utility;
(ii) detect one or more behaviour parameters of a user accessing the content, where the behaviour patterns are associated with the content either consisting of first category content or second category content; and
(iii) further classify the content into first category content and second category content based on the behaviour parameters detected for the user.

9. The system of claim 8 wherein the first category content is restricted or illegal content, and the second category content is unrestricted or legal content.

10. The system of claim 9 in which the classification utility defines at least (a) a training phase, and (b) a testing phase.

11. The system of claim 8 in which the classification utility embodies or is based on a pattern recognition technique.

12. The system of claim 10 in which the training phase provides statistical properties of a plurality of data objects which are labelled prior to testing as either restricted or unrestricted.

13. The system of claim 12 in which the testing phase to determine whether one or more data objects of content communicated via the network constitute restricted content or unrestricted content.

14. The system of claim 10 in which the data objects are analyzed to determine whether they contain more properties related to restricted content or more properties related to unrestricted content.

15. The system of claim 8 in which the network utility is a network component linked to the network.

16. A network utility that can be linked to or otherwise implemented in connection with a network, the network utility including a content detection utility that is operable to:
(a) classify the content into a first category and a second category by means of a classification utility made part of or linked to the network utility;
(b) detect one or more behaviour parameters of a user accessing the content, where the behaviour patterns are associated with the content either consisting of first category content or second category content; and
(c) further classify the content into first category content and second category content based on the behaviour parameters detected for the user.

17. The network utility of claim 16 in which the network utility is a network component such as a router.

18. The network utility of claim 16 in which the network utility is a computer program that includes computer instructions for providing the functionality of the content detection utility to a network component such as a router.

19. The network utility of claim 16 wherein the content detection utility is implemented to a network server linked to the network.

20. The network utility of claim 20 wherein the content detection utility is operable to analyze content passing through the network.
